(19) United States
(12) Patent Application Publication
(10) Pub. No.: US 2008/0111263 A1
(43) Pub. Date: May 15, 2008

(54) Method for reusing foamed material

(76) Inventor: Ming-Hui Wang, Taichung (TW)

Correspondence Address: Ming-Hui WANG, 235 Chung-Ho, Box 8-24, Taipei, omitted

(21) Appl. No.: 11/599,552

(22) Filed: Nov. 15, 2006

(51) Int. Cl. B29B 17/00; B29B 17/04

(52) U.S. Cl. 264/37.29

(57) ABSTRACT

A method for reusing foamed material comprises the steps of: crumbling waste material into smaller pieces by blocks and by batches by using a crumbling machine; extruding the crumbling waste material block into a screw rod machine and forging the block so as to destroy the molecular structures of the waste material block; grinding the waste material block into waste material powders by a grinding machine so as to increasing total surface areas of the waste material; and activating the waste material powders by adding foaming material thereinto so that the waste material powders are reacted with the foaming material so as to form, as an active foaming material.

### FIELD OF THE INVENTION

The present invention relates to a method for reusing foamed material which can be used to make products with finer structure.

### BACKGROUND OF THE INVENTION

Plastic material is a modern material and widely used in many field is and areas. However, plastics is difficult to decompose by biologically methods. If it is desired to burn the plastics for reduction the amount of plastic, some poisonous gas will generate to harm human bodies. Thus it makes a great problem in environment protection.

Most of prior art ways for manufacturing plastic products are positioned by foaming. The waste foaming material is non-active. In the prior art way for processing plastics, the waste plastic material is extruded by rollers so as to form with sheet like structures. Thus the sheet like material is used to make some products which are not fine, such as basin, tires, etc. It cannot be used to make fine material. Thus less plastic material is recycled and the use of recycled waste plastics are strictly confined.

### SUMMARY OF THE INVENTION

Accordingly, the primary object of the present invention is to provide a method for reusing foamed material which can be used to make products with finer structure.

To achieve above objects, the present invention provides method for reusing foamed material comprising the steps of: crumbling waste material into smaller pieces by blocks and by batches by using a crumbling machine; extruding the crumbling waste material block into a screw rod machine and forging the block so as to destroy the molecular structures of the waste material block; grinding the waste material block into waste material powders by a grinding machine so as to increasing total surface areas of the waste material; and activating the waste material powders by adding foaming material thereinto so that the waste material powders are reacted with the foaming material so as to form as an active foaming material.

The various objects and advantages of the present invention will be more readily understood from the following detailed description when read in conjunction with the appended drawing.

### BRIEF DESCRIPTION OF THE DRAWINGS

FIG. 1 is a flow diagram about the method of the present invention.

FIG. 2 is a schematic view showing the process of the present invention.

### DETAILED DESCRIPTION OF THE INVENTION

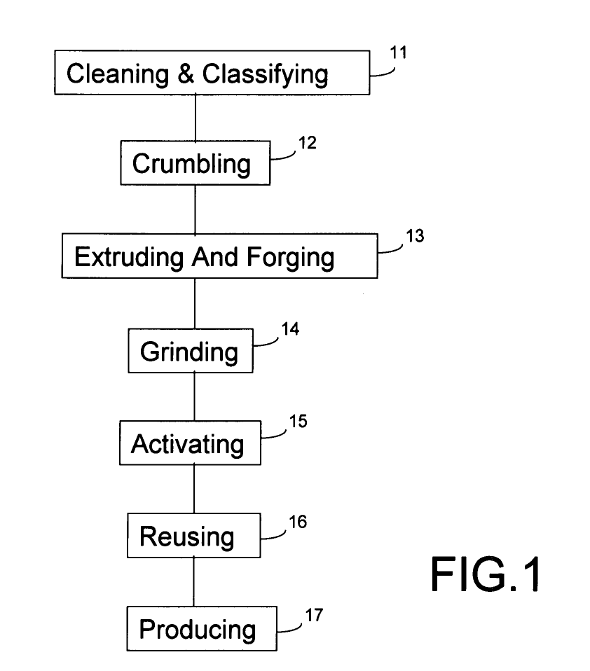

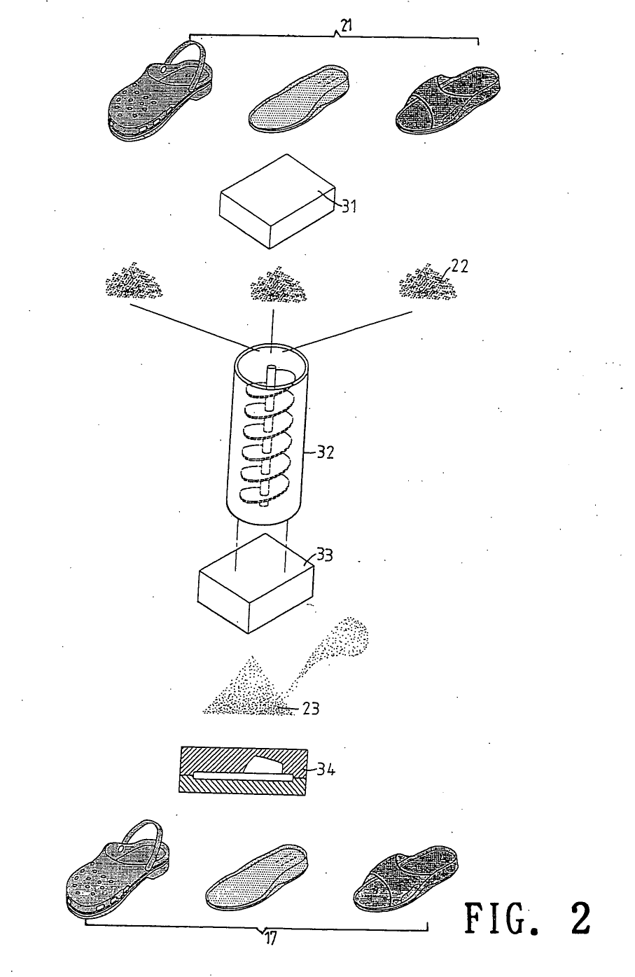

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims. Referring to FIGS. 1 and 2, the foaming method for reusing is disclosed. In the following a reusing of a shoe body is used as an example, however, the present invention is not confined to the reusing of a shoe body, other objects are also allowable. The present invention includes the following steps of:

Cleaning the foaming waste material 21 and then roughly classing the cleaned foaming material according to the colors of the material 21 (see step 11) so as to get a plurality of waste material blocks 22. The reusing waste material may contain dirt or impurities;

Crumbling the waste material 21 into smaller pieces by blocks and by batches by using a crumbling machine 31 (step 12);

Extruding the crumbling waste material block 22 into a screw rod machine 32 and forging the block 22 in a temperature of about 180° C. so as to destroy the molecular structures of the waste material block 22 (step 13);

Grinding the waste material block 22 into waste material powders 23 by a grinding machine 33 so as to increasing total surface areas of the waste material (step 14).

Activating the waste material powders 23 by adding foaming material thereinto and other auxiliary agents so that the waste material powders 23 are reacted with the foaming material to form as an active foaming material (step 15);

Reusing the active foaming material by placing the foaming material into a mold for foaming to a desired object 17 (step 16), in this example, the object is a shoe 17.

However, above process can be used for any kind of waste foamed material instead of only being used in the reusing of shoes.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for reusing foamed material comprising the steps of:
crumbling waste material into smaller pieces by blocks and by batches by using a crumbling machine;
extruding the crumbling waste material block into a screw rod machine and forging the block so as to destroy the molecular structures of the waste material block;
grinding the waste material block into waste material powders by a grinding machine to increase total surface areas of the waste material; and
activating the waste material powders by adding foaming material thereinto so that the waste material powders are reacted with the foaming material to form as an active foaming material.

2. The method as claimed in claim 1, further before crumbling, device comprising a step of cleaning foamed waste material and then roughly classing the cleaned foaming material according to the colors of the material so as to get a plurality of waste material blocks.

3. The method as claimed in claim 1, wherein forging the block is performed in a temperature of about 180° C.

4. The method as claimed in claim 1, after activating further comprising a step of: reusing the active foaming material by placing the foaming material into a mold for foaming to a desired object.

5. The method as claimed in claim 1, wherein in activating the waste material powders, auxiliary agents are added.
